(19) United States
(12) Patent Application Publication
(10) Pub. No.: US 2007/0169649 A1
(43) Pub. Date: Jul. 26, 2007

(54) PRESS OPERATION AND MANAGEMENT INFORMATION SYSTEM FOR OFFSET SHEET FED PRINTING INDUSTRY

(76) Inventors: BYUNGWOO CHO, Seoul (KR); Namsoon Kim, Seoul (KR); Kyuheang Cho, Seoul (KR); Boheang Cho, Seoul (KR)

Correspondence Address: NEUSTEL LAW OFFICES, LTD., 2534 SOUTH UNIVERSITY DRIVE, SUITE 4, FARGO, ND, 58103, US

(21) Appl. No.: 11/538,148

(22) Filed: Oct. 3, 2006

(30) Foreign Application Priority Data
Jan. 25, 2006 (KR) 10-2006-7730
Jan. 27, 2006 (JP) 2006-18320

(51) Int. Cl. B41F 13/24

(52) U.S. Cl. 101/232

(57) ABSTRACT

A press operation and management information system for offset sheet fed printing industry for accurately counting total and “good” printed paper that has gone through a printing press. The press operation and management information system for offset sheet fed printing industryincludes a system control including a control card, wherein the control card supplies data to a press. A feeder clutch is connected to the system control, wherein the feeder clutch turns on and off the press and the system control. A counting system is controlled by the system control and includes a tape inserter and a plurality of sensors. The data in the system control may be updated and reviewed by a system operation including a monitor and a printer, wherein the monitor displays a completion of pile function to print a moving tag from the printer and wherein the monitor also displays a new work function which accepts a print job not originally listed on a list of work.

### CROSS REFERENCE TO RELATED APPLICATIONS

I hereby claim benefit under 35 U.S.C. §119 of Korean patent application number 10-2006-7730 filed on Jan. 25, 2006 and Japanese patent application number 2006-18320 filed on Jan. 27, 2006. The 10-2006-7730 application and application 2006-18320 are hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to paper counting systems and more specifically it relates to a press operation and management information system for offset sheet fed printing industry for accurately counting total and “good” printed paper that has gone through a printing press.

2. Description of the Related Art

Any discussion of the prior art throughout the specification should in no way be considered as an admission that such prior art is widely known or forms part of common general knowledge in the field.

Paper counting systems have been in use for years. Typically, printing presses are equipped with a “good” counter. This counter counts the number of acceptable printed sheets that run through the offset printing process. It is then determined, after the paper is made into a communication medium (i.e. book, magazine, newspaper, etc . . . ), if the targeted number of printed sheets has been met.

Printing presses that are equipped with a “good” counter may not be accurate because of frequent stop/run (i.e. feeder/press stop, etc . . . ) operations of counter. Also, when you don't determine if the correct number of printed paper has been met until the communication medium has been prepare, you are forced to go back and start the printing press again. This can cause valuable time to be wasted, especially when the printed material is under a deadline.

While these devices may be suitable for the particular purpose to which they address, they are not as suitable for accurately counting total and “good” printed paper that has gone through a printing press. Not efficiently counting the total number of printed paper and “good” printed paper can cause a valuable loss in the amount of time it takes for a printed communication medium. It can also increase cost in printing, as you will repeatedly have to go back to the printing press to re-start the printing job in order to reach the desired target number of sheets.

No printing press has been equipped with a paper counting system for counting printed sheets. Paper count, which is a total of “good” printed paper and “bad” printed paper has not generally been counted. The current management system depends only on press “good” counter, thus paper loss is not counted and total number of paper consumed is not known.

In these respects, the press operation and management information system for offset sheet fed printing industry according to the present invention substantially departs from the conventional concepts and designs of the prior art, and in so doing provides an apparatus primarily developed for the purpose of accurately counting total and “good” printed paper that has gone through a printing press.

### BRIEF SUMMARY OF THE INVENTION

In view of the foregoing disadvantages inherent in the known types of printed sheet counting systems now present in the prior art, the present invention provides a new press operation and management information system for offset sheet fed printing industry construction wherein the same can be utilized for accurately counting total printed paper and “good” printed paper that has gone through a printing press.

The general purpose of the present invention, which will be described subsequently in greater detail, is to provide a new press operation and management information system for offset sheet fed printing industry and printed sheet counting systems that has many of the advantages of the printed sheet counting systems mentioned heretofore and many novel features that result in a new press operation and management information system for offset sheet fed printing industry which is not anticipated, rendered obvious, suggested, or even implied by any of the prior art paper counting systems, either alone or in any combination thereof.

To attain this, the present invention generally comprises a system control including a control card, wherein the control card supplies data to a press. A feeder clutch connected to the system control, wherein the feeder clutch turns on and off the press and the system control. Included also is a counting system controlled by the system control and a tape inserter and a plurality of sensors to count the total revolution of the press and paper delivered to a press delivery. The data in the system control may be updated and reviewed by a system operation including a monitor and a printer, wherein the monitor displays a completion of pile function to print a moving tag from the printer and wherein the monitor also displays a new work function which accepts a print job not originally listed on a list of work.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a press operation and management information system for offset sheet fed printing industry that will overcome the shortcomings of the prior art devices.

A second object is to provide a press operation and management information system for offset sheet fed printing industry for accurately counting total and “good” printed paper that has gone through a printing press.

Another object is to provide a press operation and management information system for offset sheet fed printing industry that accurately measures printing ink per a job.

Another object is to provide a press operation and management information system for offset sheet fed printing industry that counts the total revolution of the press, as the press “total” counter counts when an impression cylinder is turned on, wherein the “total” is always less than the actual revolution of the press.

An additional object is to provide a press operation and management information system for offset sheet fed printing industry that accurately assesses the work efficiency and sales per labor cost of each shift.

A further object is to provide a press operation and management information system for offset sheet fed printing industry that produces an accurate report of all of the printing job statistics.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is the total system of the present invention including the counting of the printed paper and production control.

FIG. 2 is the location of the sensors at press delivery.

FIG. 3 is the tape inserter.

FIG. 4 is the completed pile of printed paper.

FIG. 5 is the main control of the present invention.

FIG. 6 is a diagram showing the installation of the ink flow meter in between the press and the control card of the system control.

### DETAILED DESCRIPTION OF THE INVENTION

### A. Overview

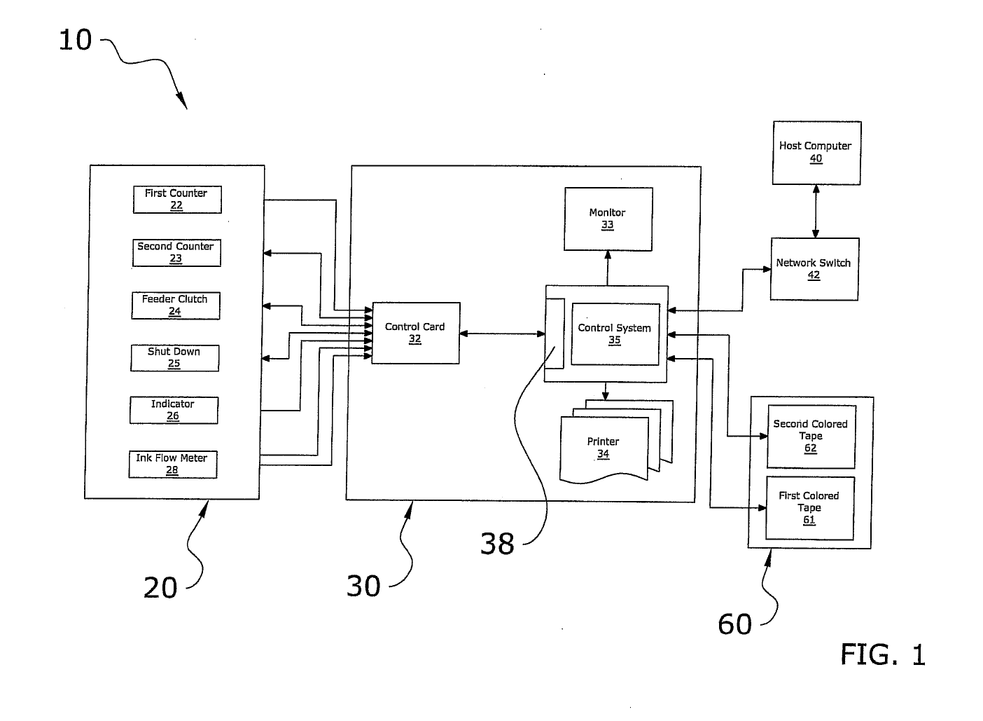

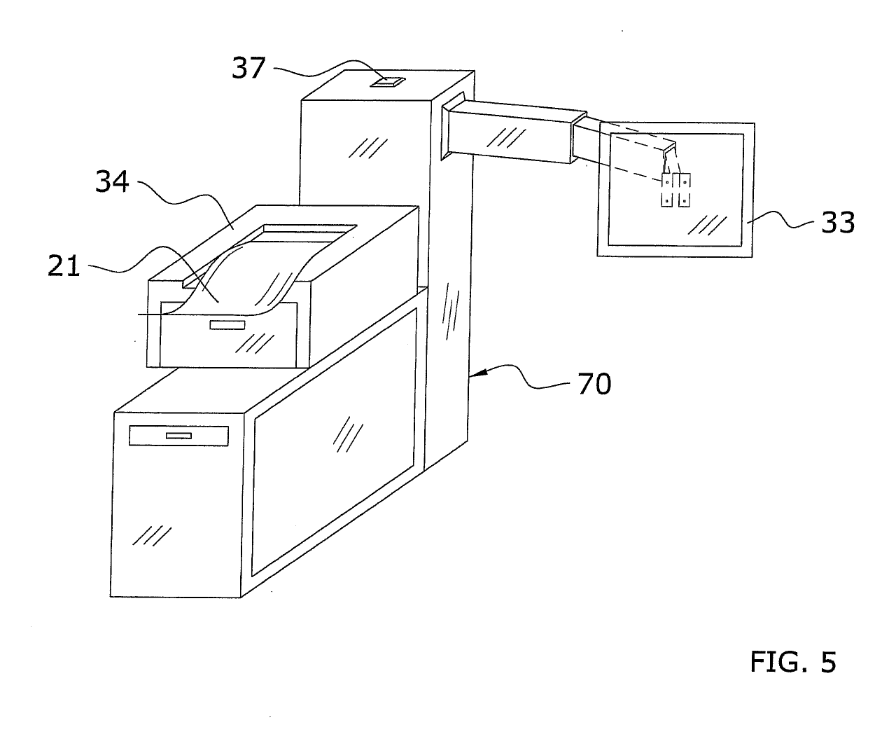

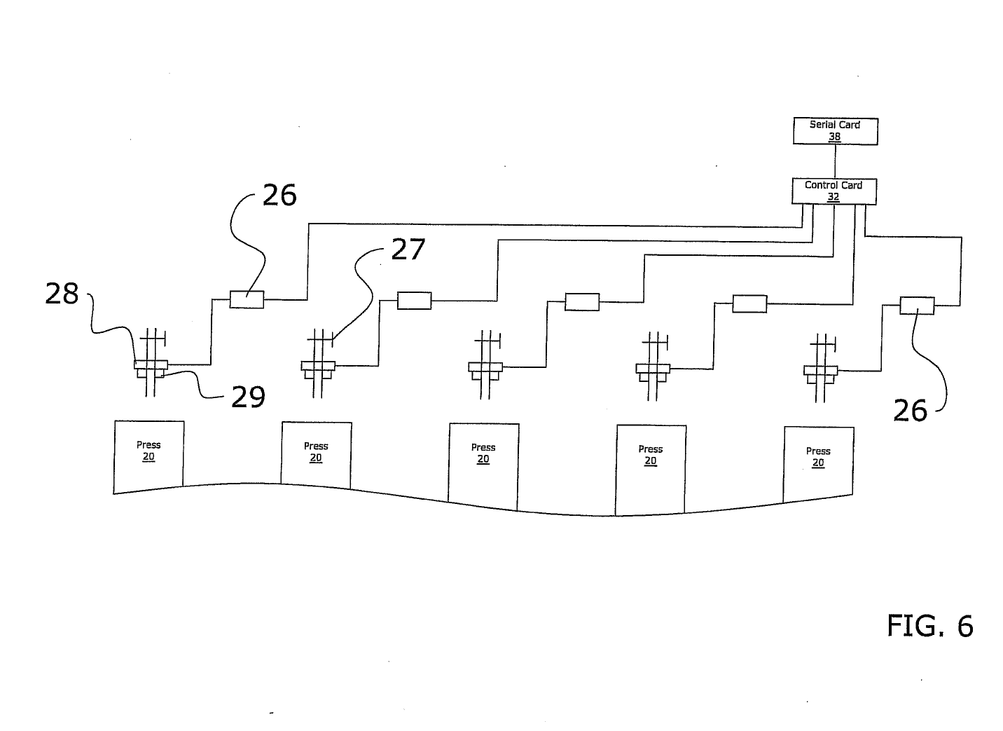

Turning now descriptively to the drawings, in which similar reference characters denote similar elements throughout the several views, FIGS. 1 through 6 illustrate a press operation and management information system for offset sheet fed printing industry 10, which comprises a system control 30 including a control card 32, wherein the control card 32 supplies data to a press 20. A feeder clutch 24 is connected to the system control 30, wherein the feeder clutch 24 turns on and off the press 20 and the system control 30. A counting system is controlled by the system control 30 and includes a tape inserter 60 and a plurality of sensors 58, 59. A series of system operations displayed on a monitor 33 and printed on a printer 34 may be utilized to update and review the system control 30 data, wherein the monitor 33 displays a “completion of pile” function to print a “moving tag” 21 from the printer 34 and wherein the monitor 33 also displays a “new work” function which accepts a print job not originally listed on a “list of work”.

### B. System Control

The system control 30 is comprised of a configuration to efficiently send and receive data for printing jobs. The system control 30 preferably produces an accurate Enterprise Resource Planning (ERP) report. The system control 30 preferably includes a control system 35, a monitor 33, a printer 34 and a control card 32. The system control 30 is preferably housed in a control cabinet 70. The control system 35 is supplied with the system information. From the plethora of system information, the control system 35 computes statistical data relating to the printing job.

The plethora of system information includes a weekly production plan and a daily plan. The daily plan includes a list of today's job, where the list of today's job shows a list of today's assigned job for a certain press 20. The daily plan also includes an instruction of job, where the instruction of job shows details of daily printing job, a list of work, a job report and a moving tag 21. The job report automatically generates a report for production control when the current printing job is finished. The moving tag 21 is printed from the printer 34 as one job or one pile of printed paper 12 is completed. The printer 34 preferably prints 3 or 4 copies of moving tags 21 to each pile of printed paper 12 and additional copies to desired production workers.

The printing of job report and moving tag 21 preferably increases the time for an operator to quality of the printing job because they do not have to manually fill out the job report and moving tag 21 continuously throughout the workday. The moving tag 21 preferably accurately reports the pile number and the total amount of good printed paper 12.

The control system 35 computes a set of statistical data including a record of printing, a paper usage, a paper loss per run length and kind of paper, a usage of printing plate, a usage of printing ink, a work efficiency of each shift and a cause of press 20 stop from the plethora of system information.

During system operations, the control system 35 displays this statistical data on the monitor 33 for the operator to monitor 33. The monitor 33 is set up in a configuration to receive data from the control system 35. The monitor 33 is preferably comprised of a touch monitor 33 structure. The monitor 33 displays a set of statistical data relating to the current printing job, where the current printing job is created by the control system 35. The statistical data may also be printed on the printer 34 for the operators convenience.

The control system 35 is also preferably connected to the control card 32. The control card 32 preferably connects to the control system 35 through a serial card 38. The serial card 38 is preferably comprised of a standard RS-232 serial card 38. The control card 32 preferably connects the system control 30 to the press 20. The plethora of system information is able to pass through the control card 32 to the press 20. This ensures that the press 20 will print the correct number of printed sheets 12.

The feeder control is preferably comprised of an electro magnetic structure and configuration. The feeder control includes the feeder clutch 24 and the feeder clutch 24 is preferably connected to the press 20. A power source is supplied to activate the feeder clutch 24, with the power source preferably being 24 volts. In the event that the power is cut, the clutch 24 is preferably deactivated to stop the press 20. A sensor cable connected between the system control 30 and the feeder clutch 24 preferably transfers an existence of electricity to the system control 30 so that the system control 30 may recognize if the feeder clutch 24 is on or off.

### C. Press

The press 20 is connected to the system control 30 and is preferably of a structure and configuration of a sheet-fed press 20. The press 20 preferably includes a first counter 22 and a second counter 23. The first counter 22 preferably keeps track of the total count of the printed paper 12. The second counter 23 preferably keeps track of the good count of the printed paper 12. The good count is the total count minus the wasted paper.

The press 20 also includes an ink( flow meter 28 and a shut down 25 switch. The ink flow meter is preferably positioned in-between the press 20 and the control card 32 of the system control 30. The ink flow meter 28 is preferably connected to the control card 32 of the system control 30 through an indicator 26. The volume of ink is preferably measured by each printing job and also preferably every month to ensure proper printing quality.

### D. Host Computer

A host computer 40 is preferably connected to the control system 35 of the system control 30 through a network. The host computer 40 preferably receives information from the system control 30. The host computer 40 preferably monitors a production status of the system control 30 and the press 20 in real time to ensure proper accuracy of the current printing jobs.

### E. Counting System

The counting system is preferably of a structure and configuration to be able to accurately count a total number of printed sheets 12 and a total number of acceptable printed sheets 12 as well as the total number of press 20 revolutions. The counting system preferably includes a tape inserter 60 and at least one sensor 58, 59.

i. Tape Inserter

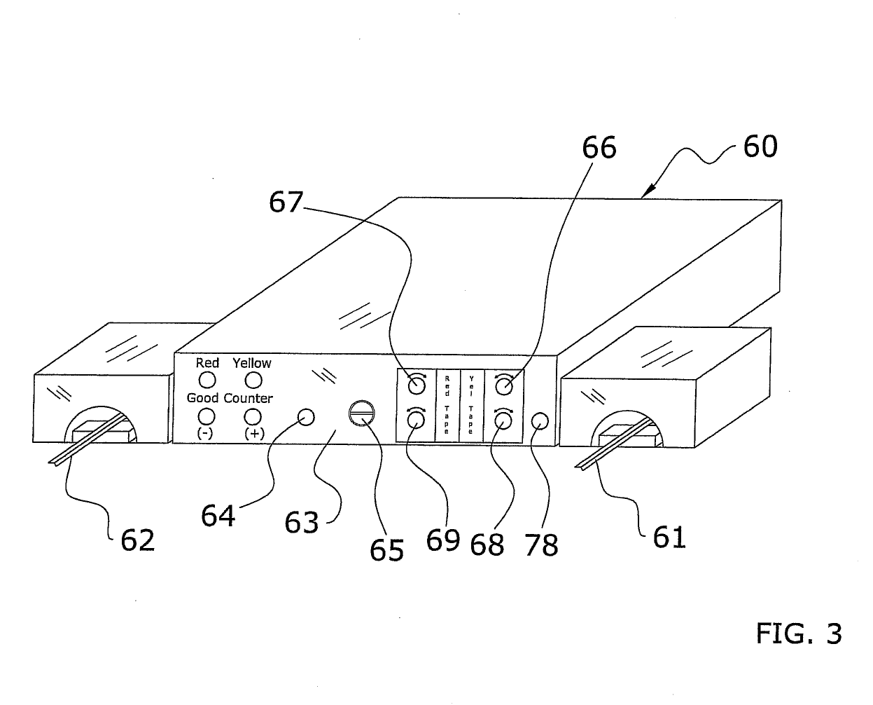

The tape inserter 60 is preferably of a structure and configuration to feed a first tape 61 and a second tape 62 to the press 20, as shown in FIG. 3. The first tape 61 is preferably a yellow color and the second tape 62 is preferably of a red color. The first tape 61 preferably marks an index to keep track of a total count of printed paper 12 and is usually marked at an index of 100 or 500 units of print. The second tape 62 preferably indicates if the printed paper 12 is waste or bad printed paper 12.

The second tape 62 preferably marks a beginning of wasted printed sheets 12 and an ending of wasted printed sheets 12. The printed sheets 12 in-between and including the beginning of wasted printed sheets 12 and the ending of wasted printed sheets 12 is preferably set to waste.

The second tape 62 is preferably inserted at the right hand side of the operator. This increases recognition of bad printed paper 12. The opposite side shows the first tape 61 or index tape, as shown in FIG. 3. The first tape 61 and the second tape 62 are preferably simultaneous inserted when one print job is meant to differentiate from a different print job. The control panel 63 of tape inserter 60 preferably includes a “time” function, as shown in FIG. 3. The “time” function is set to the time when a colored tape 61, 62 should be inserted. The colored tape 61, 62 is generally inserted after a few printed sheets 12 from the top sheet of delivery. “Not to fly tape” and “cutting” is the length of colored tape 61, 62 to insert.

A “positive” function of good counter serves to add one sheet by one push of the “positive” function, as shown in FIG. 3. This is preferably done after inspection of bad printed paper 12. A “negative” function is also included in the tape inserter 60 and allows the operator to remove one printed sheet 12 from the total count when more bad printed sheets 12 are found.

The system control 30 preferably alerts the operator at approximately 10 percent of targeted number of printed paper 12. The operator is further preferably alerted through the use of a pilot lamp 37 turning on. Once 100 percent of the targeted number of printed paper 12 is reached the press 20 automatically stops, thus preventing the press 20 from printing excessive or not enough printed paper.

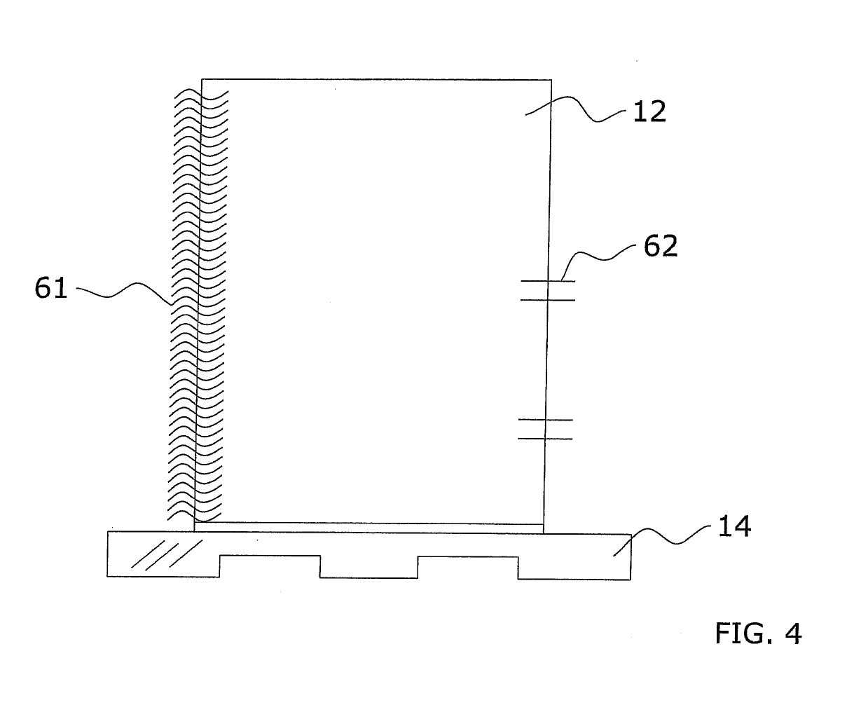

At the beginning of the printing process, an operator preferably passes a number of paper sheets through the press 20 for waste. This is done so as to have better inking through the printing process and is called initial waste. The second tape 62 is preferably inserted after the initial waste and also at the time the feeder clutch 24 turns off or on. This is to show the position of the bad or wasted printed paper 12. This wasted printed paper 12 is preferably deleted or thrown out either through inspection of after the printing process. When one pile of printed paper 12 is completed, the operator pushes a “completion of pile” button to indicate that one unit of printing is finished, as shown in FIG. 4.

The control panel 63 of the tape inserter 60 also preferably includes a hold 64 function and a power 65 function, as shown in FIG. 3. The hold 64 function temporarily stops the tape inserter 60 from functioning and the power 65 function preferably turns the tape inserter 60 on and off. The tape inserter 60 also preferably includes a first timer 66 and a second timer 67.

The first timer 66 preferably sets the desired time to insert the fist colored tape 61 and the second timer 67 preferably sets the desired time to insert the second tape 62. The tape inserter 60 also preferably includes a first cutting control 68 and a second cutting control 69. The first cutting control 68 and the second cutting control 69 preferably set the desired length used of the first tape 61 and the second tape 62. The second tape 62 may also preferably be manually inserted by a manually insertion 78 button located on the control panel 63 of the tape inserter 60.

ii. Sensors

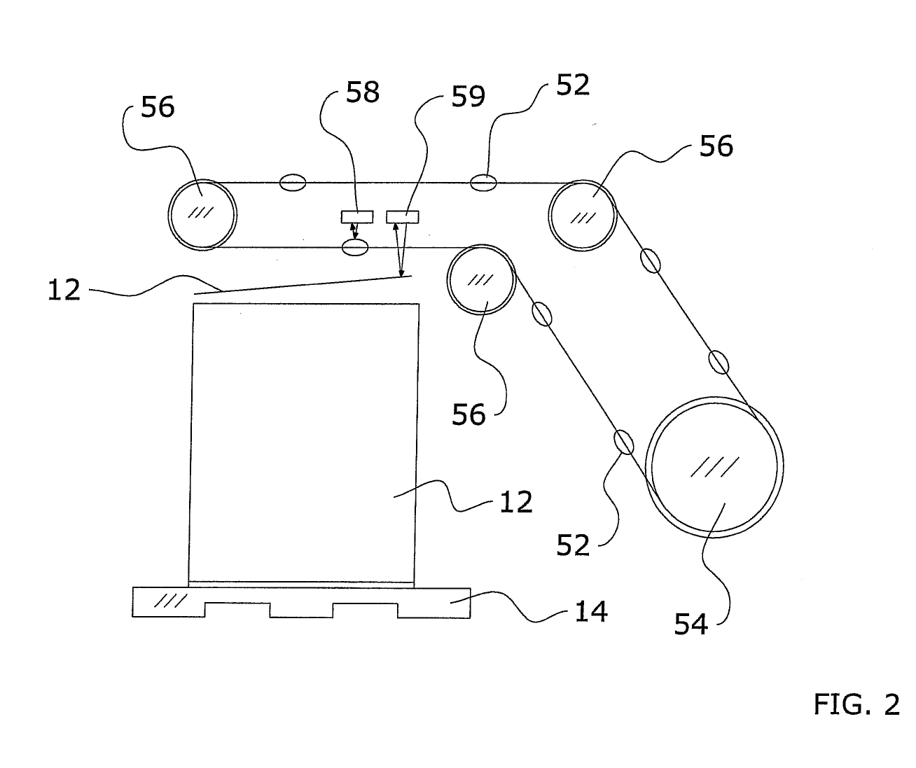

A delivery chain 50 is cycled through a loop by a delivery cylinder 54 and a plurality of sprockets 56, as shown in FIG. 2. There are preferably a total of seven to nine gripper bars 52 according to the press maker, where the gripper bars 52 are evenly spaced on the delivery chain 50 and one gripper bar 52 going through the cycle indicates one revolution of the press 20. As the gripper bars 52 cycle through the loop, each gripper bar 52 grips onto a piece of printed paper 12.

The sensors preferably include a first sensor 58 and a second sensor 59. The first sensor 58 is preferably comprised of a fiber sensor structure and configuration. The fist sensor 58 is preferably installed in a position to detect the gripper bar 52, where the first sensor 58 counts the total revolutions of the press 20. The second sensor 59 is preferably comprised of a photo sensor structure and configuration.

The second sensor 59 is preferably positioned where the printed paper 12 is being released from the gripper bar 52 and before the printed paper 12 reaches the pile of printed paper 12. The second sensor 59 has a good possibility of misdetection due to the vibration of the printed paper 12 as the number of paper sheets 12 that pass by. To avoid this counting error, the system control 30 is set up to count only one printed sheet 12 when the second sensor 59 and the first sensor 58 are triggered at the same time. The total count by the counting system is preferably tabulated as follows, with 0 indicating a signal and X indicating no signal:

| | | | | |
|---|---|---|---|---|
| First sensor | 0 | 0 | X | 0 |
| Second sensor | 0 | 4 | 0 | X |
| Paper Count | 1 | 1 | | |

### F. In Use

The feeder clutch 24 is preferably engaged to start the press 20 and activates the system control 30. The system control 30 then activates the tape inserter 60 and the colored tape 61, 62. The good counter of the counting system then connects to a shut down 25 circuit of the press 20 when the reached targeted number of printed sheets 12 has been reached via system control 30.

If waste print comes from the press 20, the operator touches RED on the tape inserter 60 to designate beginning waste. It is usual practice of printing to remove 3 to 10 sheets of printed paper 12 from a delivery pile when the feeder stops. Although, the exact number of printed paper 12 to remove depends on the desired printed quality of the printed paper 12. The press operation and management information system for offset sheet fed printing industry 10 generally has the waste number set between 0 to any number, but usually within 20.

In case the number of wasted printed paper 12 is set to 3 sheets when the feeder stops, the last 3 sheets out of 20 are considered wasted printed paper 12. When the feeder restarts, the first 3 sheets are wasted printed paper 12. The second tape 62 or red tape is inserted exactly at the 17^{th} printed paper 12 and the 4^{th} printed paper 12, with a total of 6 printed sheets 12 being waste print, with the second tape 62 inserted at the top and bottom.

In case the operator removes the previous waste print from press 20 delivery, the operator inspects the waste printed paper 12 and returns the good printed paper 12 back to the delivery. For these cases, the control panel 63 of the tape inserter 60 is adjusted. Particularly the “positive” and “negative” functions are adjusted one by one, as the operator finds more good print or waste print.

The control system 35 of the press operation and management information system for offset sheet fed printing industry 10 counts only good prints, excluding waste prints during times when the feeder is on or off. The control system 35 preferably blinks a pilot lamp 37 to warn the operator that a print job is almost finished. When the target number is reached, the feeder stops. The target number is preferably set to the printed paper 12 target number plus the wasted printed paper 12.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

We claim:

1. A press operation and management information system for offset sheet fed printing industry, comprising:
a printing press including a first plurality of paper sheets, wherein said first plurality of paper sheets includes a second plurality of paper sheets;
wherein said second plurality of paper sheets includes a beginning sheet and an ending sheet and wherein said second plurality of paper sheets is comprised of said second plurality of paper sheets in-between and including said beginning sheet and said ending sheet;
a counting system including a first tape and a second tape, wherein said first tape attaches to said beginning sheet and wherein said second tape attaches to said ending sheet;
wherein said first tape and said second tape identify said second plurality of paper sheets; and
a system control to identify a third plurality of paper sheets, wherein said third plurality of paper sheets is comprised of said second plurality of paper sheets subtracted from said first plurality of paper sheets.

2. The press operation and management information system for offset sheet fed printing industry of claim 1, including:
a tape inserter to dispense said first tape and said second tape, wherein an interval at which said tape inserter dispenses said first tape and said second tape is electronically controlled by said system control.

3. The press operation and management information system for offset sheet fed printing industry of claim 2, wherein said tape inserter includes an indexing tape, wherein said indexing tape attaches to said first plurality of paper sheets to indicate a total number of said first plurality of paper sheets.

4. The press operation and management information system for offset sheet fed printing industry of claim 1, wherein said counting system includes at least one sensor to identify a total number of said first plurality of paper sheets.

5. The press operation and management information system for offset sheet fed printing industry of claim 4, wherein said at least one sensor is comprised of a photo sensor.

6. The press operation and management information system for offset sheet fed printing industry of claim 4, wherein said at least one sensor is comprised of a fiber sensor.

7. The press operation and management information system for offset sheet fed printing industry of claim 1, wherein said counting system includes a first sensor and a second sensor, wherein said first sensor is comprised of a photo sensor and wherein said second sensor is comprised of a fiber sensor, wherein said first sensor and said second sensor identify a total number of said first plurality of paper sheets.

8. The press operation and management information system for offset sheet fed printing industry of claim 1, wherein said counting system includes an alerting member, wherein said alerting member alerts an operator when said printing press substantially nears a desired total amount of said third plurality of paper sheets.

9. The press operation and management information system for offset sheet fed printing industry of claim 8, wherein said alerting member is comprised of a pilot lamp configuration.

10. The press operation and management information system for offset sheet fed printing industry of claim 1, wherein said system control automatically generates a job report at the end of a printing job, wherein said job report details a total amount of said third plurality of paper sheets.

11. A press operation and management information system for offset sheet fed printing industry, comprising:
a printing press including a first plurality of paper sheets, wherein said first plurality of paper sheets includes a second plurality of paper sheets;
wherein said second plurality of paper sheets includes a beginning sheet and an ending sheet and wherein said second plurality of paper sheets is comprised of said second plurality of paper sheets in-between and including said beginning sheet and said ending sheet;
a counting system including a tape inserter, wherein said tape inserter includes first tape and a second tape, wherein said first tape attaches to said beginning sheet and wherein said second tape attaches to said ending sheet;
wherein said first tape and said second tape identify said second plurality of paper sheets; and
a system control to identify a third plurality of paper sheets, wherein said third plurality of paper sheets is comprised of said second plurality of paper sheets subtracted from said first plurality of paper sheets;
wherein an interval at which said tape inserter dispenses said first tape and said second tape is electronically controlled by said system control.

12. The press operation and management information system for offset sheet fed printing industry of claim 11, wherein said tape inserter includes an indexing tape, wherein said indexing tape attaches to said first plurality of paper sheets to indicate a total number of said first plurality of paper sheets.

13. The press operation and management information system for offset sheet fed printing industry of claim 11, wherein said counting system includes at least one sensor to identify a total number of said first plurality of paper sheets.

14. The press operation and management information system for offset sheet fed printing industry of claim 13, wherein said at least one sensor is comprised of a photo sensor.

15. The press operation and management information system for offset sheet fed printing industry of claim 13, wherein said at least one sensor is comprised of a fiber sensor.

16. The press operation and management information system for offset sheet fed printing industry of claim 11, wherein said counting system includes a first sensor and a second sensor, wherein said first sensor is comprised of a photo sensor and wherein said second sensor is comprised of a fiber sensor, wherein said first sensor and said second sensor identify a total number of said first plurality of paper sheets.

17. The press operation and management information system for offset sheet fed printing industry of claim 11, wherein said counting system includes an alerting member, wherein said alerting member alerts an operator when said printing press substantially nears a desired total amount of said third plurality of paper sheets.

18. The press operation and management information system for offset sheet fed printing industry of claim 17, wherein said alerting member is comprised of a pilot lamp configuration.

19. The press operation and management information system for offset sheet fed printing industry of claim 11, wherein said system control automatically generates a job report at the end of a printing job, wherein said job report details a total amount of said third plurality of paper sheets.

20. A press operation and management information system for offset sheet fed printing industry, comprising:
a printing press including a plurality of paper sheets; and
a counting system utilizing a means for counting a total number of press revolutions, a total number of said plurality of paper sheets and a “good” number of said plurality of paper sheets.
